(19) United States
(12) Patent Application Publication
(10) Pub. No.: US 2008/0289811 A1
(43) Pub. Date: Nov. 27, 2008

(54) CONSTANT TEMPERATURE CONTROLLER

(75) Inventor: Tomoyuki Kariya, Koshigaya-shi (JP)

Correspondence Address: BROWDY AND NEIMARK, P.L.L.C.;624 NINTH STREET, NW, SUITE 300, WASHINGTON, DC, 20001-5303, US

(73) Assignee: ATS Japan Corp., Koshigaya-shi (JP)

(21) Appl. No.: 12/042,875

(22) Filed: Mar. 5, 2008

(30) Foreign Application Priority Data
May 23, 2007 (JP) 2007-136188

(51) Int. Cl. G05D 23/00

(52) U.S. Cl. 165/300

(57) ABSTRACT

Cool fluid of a predetermined temperature is supplied to a three-way valve 20 of a sub unit 2 from a cooling side tank 43 of a main unit 1 of a controller, through a supply pipe 14. Hot fluid of a predetermined temperature is supplied to the three-way valve 20 from a heating side tank 44 through another supply pipe 15. The cool and hot fluids are mixed in a predetermined ratio by the three-way valve 20 according to a temperature of the external heat load 7, and supplied to a heat exchange chamber of the external heat load 7, to maintain the temperature thereof at a target temperature. The temperature of the external heat load 7 is measured by one of a sensor 72 in a processing chamber, a sensor 23 in a constant temperature fluid supply pipe, and a sensor 24 in a constant temperature fluid return pipe, for feedback control of aperture of the three-way valve 20. Thereby, the highly heat-responsive and accurate constant temperature controller which is capable of following up sharp temperature fluctuation of an external heat load is provided.

### BACKGROUND

1. Technical Field

The present invention relates to a constant temperature controller for maintaining the temperature of an external heat load apparatus at a constant level, and more particularly to a constant temperature controller that circulates a heat medium fluid of a constant temperature so as to maintain the temperature of the external heat load apparatus constant, for example employed in a chiller unit incorporated in a semiconductor manufacturing apparatus.

2. Related Art

Innovative semiconductor manufacturers are developing next-generation microprocessors of 45 nm scale. The manufacturing process of such microprocessors requires a large-capacity temperature control unit that is accurate, and highly responsive to temperature in particular, in order to constantly maintain a predetermined temperature of a plasma etching equipment or the like, which imposes an especially high heat load. Currently, a constant temperature controller, generally called a chiller unit, is popularly employed for this purpose.

Such constant temperature controller is generally designed to circulate a heat medium fluid through a pipeline arranged in a loop through a cooler, a heater and an external heat load apparatus, so as to once supercool the liquid medium heated by the external heater with the cooler, and to heat the supercooled liquid medium with the heater, thus to supply the external heat load apparatus with the liquid medium of a predetermined temperature required by the external heat load apparatus

In such control unit, normally the cooler is constantly outputting the rated cooling power irrespective of whether the external heat load apparatus is working. This leads to continuous consumption of a large power, especially in the case where the cooling is executed by a freezer. Therefore, JP-A No. 2004-169933 proposes a constant temperature controller that can switch between an operation mode and an energy-saving mode according to the operation status of the external heat load apparatus.

Also, the cooler of the constant temperature controller is usually set such that the temperature of the liquid medium agrees with the target temperature at the outlet port of the cooler. However, because of slow heat transmission of the coolant gas (such as a CFC gas) in the freezer cycle of the cooler, the temperature of the liquid medium often becomes considerably higher (overshooting) or lower (undershooting) than the target temperature after once reaching the target temperature. This imposes a heavier burden on the heater, and hence a larger heater capable of controlling a wider temperature range has to be employed.

Accordingly, JP-A No. 2001-153518 and USP-A No. 20060237181 propose providing another temperature control unit, outside the constant temperature controller and close to the external heat load apparatus, for micro-adjusting the temperature of the heat medium.

[Patented document 1] JP-A No. 2004-169933

[Patented document 2] JP-A No. 2001-153518

[Patented document 3] USP-A No. 20060237181

The patented document 1 discloses a chiller control unit that employs a computer that pre-reads recipe information on a process sequence of the plasma etching processor, so as to switch the chiller unit to the operation mode or to the energy-saving mode, when the etching process enters a certain duration of downtime or when the etching process is resumed.

Such chiller control unit, however, requires the computer and associated signal lines and so on, for constantly monitoring the operation status of the apparatus under the temperature control, and transmitting the status information to the control system of the chiller unit.

The patented document 2 discloses a temperature control system that includes a second temperature control unit separated from the chiller unit and located close to the processing apparatus to be controlled, for setting the temperature at the outlet port of the chiller unit and micro-adjusting the temperature of the heat medium supplied to the processing apparatus, depending on the temperature of the processing apparatus.

In this case, the first temperature control unit is engaged in executing the temperature control over a wider range, and all that the second temperature control unit has to do is to micro-adjust the temperature, once roughly controlled by the first temperature control unit. Accordingly, this document proposes a system for a chiller unit, which employs a heater for heating purpose and a fluid cooled by a cooler for cooling purpose, as the temperature control unit for the second temperature control unit, based on the idea that it suffices to provide a mechanism capable of performing an accurate control within a small range, without taking temperature fluctuation of a wider range into consideration.

The above system has, however, the drawback that a time rag is incurred from sharp temperature fluctuation, since the sharp fluctuation is taken care of by the first temperature control unit, and hence satisfactory thermal response cannot be obtained. Consequently, the system according to the patented document 2 is unsuitable for controlling the temperature of the processing chamber for the 45 nm class microprocessors, which often causes sharp temperature fluctuation.

The system according to the patented document 3 includes a cooling unit having only the cooling function and a remote temperature control module (hereinafter, RTCM) that executes heat exchange between the coolant from the cooling unit and a circulating fluid for cooling the external heat load apparatus, to thereby perform feedback control of the temperature of the heat exchange unit of the RTCM, according to the temperature of the external heat load apparatus. Providing thus the RTCM close to the external heat load apparatus, and away from the cooling unit, allows improving the accuracy in temperature control.

Also, since the RTCM is isolated from the cooling unit, a plurality of RTCMs may be additionally provided for a single cooling unit. Such system has the advantages that, for example, one unit each of the RTCM can be provided for a plurality of processing chambers (multiple chambers) of the semiconductor manufacturing equipment, and that each RTCM can be independently operated for the temperature control.

In the system according to the patented document 3, however, the heat exchange is indirectly executed through the heat exchange equipment in the RTCM, between the coolant and the circulating fluid. The indirect heat exchange generally incurs greater heat loss and degraded temperature response, and is hence unsuitable for controlling the temperature of the processing chamber for the 45 nm class microprocessors, which often causes sharp temperature fluctuation

Besides, a large-scale power supply line has to be provided for each module because a heater is provided for heating the RTCM, which inevitably leads to an increase in dimensions and further complication of the apparatus.

Accordingly, an object of the present invention is to provide a highly heat-responsive and accurate constant temperature controller, capable of following up sharp temperature fluctuation of an external heat load apparatus.

Another object of the present invention is to provide an inexpensive constant temperature controller that allows incorporating a plurality of sub units for a single main unit, and independently setting a different temperature for each of the sub units.

Still another object of the present invention is to provide an inexpensive constant temperature controller that provides assured temperature response and temperature accuracy, despite that the main unit is installed away from the external heat load apparatus.

### SUMMARY OF THE INVENTION

The present invention provides a constant temperature controller comprising a main unit, including a high-temperature circulating heat medium fluid preparation unit that produces a high-temperature circulating heat medium fluid adjusted to a predetermined temperature and a low-temperature circulating heat medium fluid preparation unit that produces a low-temperature circulating heat medium fluid adjusted to a predetermined temperature; and a sub unit including a constant temperature circulating heat medium fluid preparation unit that directly mixes the high-temperature circulating heat medium fluid and the low-temperature circulating heat medium fluid and controls a flow volume ratio between the high-temperature circulating heat medium fluid and the low-temperature circulating heat medium fluid according to a temperature of an external heat load apparatus, to thereby produce a circulating heat medium fluid of a predetermined target temperature.

The high-temperature circulating heat medium fluid preparation unit may employ at least one of a high-temperature side heat medium obtained from a freezer cycle, a heater, and plant utility water as a heat source thereof, and the low-temperature circulating heat medium fluid preparation unit may employ at least one of a lower-temperature side heat medium obtained from the freezer cycle, a heater, and the plant utility water as a heat source thereof.

Accordingly, the high-temperature side heat medium obtained from the freezer cycle may be employed as the heat source for the high-temperature circulating heat medium fluid preparation unit, and the low-temperature side heat medium obtained from the freezer cycle may be employed as the heat source for the low-temperature circulating heat medium fluid preparation unit. Under this system, the heater may be additionally employed for micro-adjusting the temperature of the high-temperature circulating heat medium fluid and/or the low-temperature circulating heat medium fluid. Also, since this system employs the waste heat, higher thermal efficiency can be achieved.

Otherwise, the heater may be employed as the heat source for the high-temperature circulating heat medium fluid preparation unit, and the plant utility water may be employed as the heat source for the low-temperature circulating heat medium fluid preparation unit.

Otherwise, the heater may be employed as the heat source for the high-temperature circulating heat medium fluid preparation unit, and the lower-temperature side heat medium obtained from the freezer cycle may be employed as the heat source for the low-temperature circulating heat medium fluid preparation unit.

Still otherwise, the plant utility water may be employed as the heat source for the high-temperature circulating heat medium fluid preparation unit, and the lower-temperature side heat medium obtained from the freezer cycle may be employed as the heat source for the low-temperature circulating heat medium fluid preparation unit.

Still otherwise, in a factory where high-temperature plant utility water and low-temperature plant utility water are both available, the high-temperature plant utility water may be employed as the heat source for the high-temperature circulating heat medium fluid preparation unit, and the low-temperature plant utility water may be employed as the heat source for the low-temperature circulating heat medium fluid preparation unit.

Thus, the heat medium obtained from the freezer cycle, the plant utility water and the heater may be employed in various other combinations as the heat source for the high-temperature side and the low-temperature side. In particular, employing the heater in combination with another heat source is advantageous form icro-adjusting with the target temperature.

The constant temperature circulating heat medium fluid preparation unit may include a three-way valve having an inlet port through which the high-temperature circulating heat medium fluid is introduced, an inlet port through which the low-temperature circulating heat medium fluid is introduced, an outlet port through which the constant temperature circulating heat medium fluid is discharged, and a control valve that controls the flow volume ratio between the high-temperature circulating heat medium fluid and the low-temperature circulating heat medium fluid; and a stirring, mixing and emitting unit that stirs, mixes and emits the constant temperature circulating heat medium fluid. Preferably, a three-way valve control unit may be provided for controlling the aperture of the control valve that controls the flow volume ratio between the high-temperature and the low-temperature heat medium fluid, according to the temperature of the external heat load apparatus.

The three-way valve control unit has a feedback control function for controlling the flow volume ratio between the high-temperature circulating heat medium fluid and the low-temperature circulating heat medium fluid introduced thereinto, according to one of the temperature of the constant temperature circulating heat medium fluid being supplied to the external heat load apparatus, the temperature of the constant temperature circulating heat medium fluid being discharged from the external heat load apparatus, and the temperature of the working point of the external heat load apparatus.

Attaching a temperature sensor for direct temperature measurement to the external heat load apparatus offers an optimal thermal response. More specifically, in the case where the external heat load apparatus is a processing chamber of a semiconductor manufacturing equipment, it is preferable to attach the temperature sensor so as to measure the temperature of a platform for semiconductor wafers, a platform of the high-frequency plasma equipment, or a wall surface of the processing chamber.

In the case where it is difficult to directly attach the temperature sensor to the external heat load apparatus, the temperature sensor may be provided either on a pipe through which the constant temperature circulating heat medium fluid is supplied from the sub unit to the external heat load apparatus, or a return pipe through which the constant temperature circulating heat medium fluid returns from the external heat load apparatus to the sub unit. In this case, providing the temperature sensor on the return pipe is more preferable, because in this way higher thermal response can be achieved.

It is preferable to employ one of a stepping motor, a servo motor, or a pressure-driven diaphragm for driving the control valve of the three-way valve, and to adopt a PID control for executing the feedback control.

For the mixing and supplying unit, it is preferable to employ a turbo type fluid pump which offers a prominently high stirring power, because the high-temperature circulating heat medium fluid and the low-temperature circulating heat medium fluid have to be uniformly mixed in a short time. Also, it is preferable to employ an inverter-driven pump, which is easy to control the flow volume and the pressure of the pump.

Examples of the turbo type fluid pump include a centrifugal pump, a diffuser pump, and a cascade pump.

The main unit and the sub unit are separated from each other, and connected via a supply pipe of the high-temperature circulating heat medium fluid, a supply pipe of the low-temperature circulating heat medium fluid, and a return pipe of the constant temperature circulating heat medium fluid. It should be noted that it is essential to locate the sub unit close to the external heat load apparatus, in order to achieve satisfactory thermal response.

The constant temperature controller according to the present invention offers the following advantages.

(1) Since the high-temperature circulating heat medium fluid and the low-temperature circulating heat medium fluid are directly mixed to thereby produce the constant temperature circulating heat medium fluid, the circulating heat medium fluid of a desired target temperature can be immediately prepared even when the temperature of the external heat load apparatus sharply fluctuates, and hence extremely high thermal response can be achieved.

(2) The constant temperature circulating heat medium fluid preparation unit employs the three-way valve including the control valve that controls the flow volume ratio between the high-temperature circulating heat medium fluid and the low-temperature circulating heat medium fluid, and the mixing and supplying unit of the mixed solution of the high-temperature circulating heat medium fluid and the low-temperature circulating heat medium fluid includes a turbo type fluid pump having a high mixing power. Such structure allows uniformly and quickly mixing those heat medium fluids so as to immediately prepare the constant temperature circulating heat medium fluid, thus constituting a highly heat-responsive and accurate constant temperature controller, capable of immediately following up the sharp fluctuation of the target temperature, for example in the next-generation semiconductor wafer processing system (multistep system).

(3) Since the main unit and the sub unit are separated from each other, a plurality of sub units may be provided for a single main unit, to thereby readily cope with what is known as the multiple chamber system.

(4) Since the main unit and the sub unit are separated from each other, the sub unit can be located close to the external heat load apparatus, thereby further upgrading the thermal accuracy.

(5) Since the main unit and the sub unit are separated from each other, one each of the sub unit can be provided for a plurality of external heat load apparatuses with different target temperatures This allows a single main unit to deal with a plurality of external heat load apparatuses, which simplifies the controlling and refilling work of the circulating fluid for the main unit.

### BRIEF DESCRIPTION OF THE DRAWINGS

FIG. 1 is a block diagram showing a configuration of a constant temperature controller according to the present invention;

FIG. 2 is a schematic diagram showing a system configuration of a main unit according to a first embodiment of the present invention;

FIG. 3 is a schematic diagram showing a system configuration of a sub unit according to the first embodiment;

FIG. 4 is a wiring diagram showing a configuration of a control unit according to the first embodiment;

FIG. 5 is a cross-sectional view of a three-way valve;

FIG. 6 is a cross-sectional view for explaining a heating operation of the three-way valve;

FIG. 7 is a cross-sectional view for explaining a cooling operation of the three-way valve;

FIG. 8 is a cross-sectional view for explaining a temperature control operation of the three-way valve;

FIG. 9 is a flowchart showing an operation of the main unit;

FIG. 10 is a flowchart showing an operation of the sub unit;

FIG. 11 is a schematic diagram showing a system configuration according to a second embodiment of the present invention; and

FIGS. 12A and 12B are line graphs for comparison of thermal response between the present invention and a conventional system.

### DETAILED DESCRIPTION

Hereunder, exemplary embodiments of the constant temperature controller according to the present invention will be described, referring to the drawings.

### First Embodiment

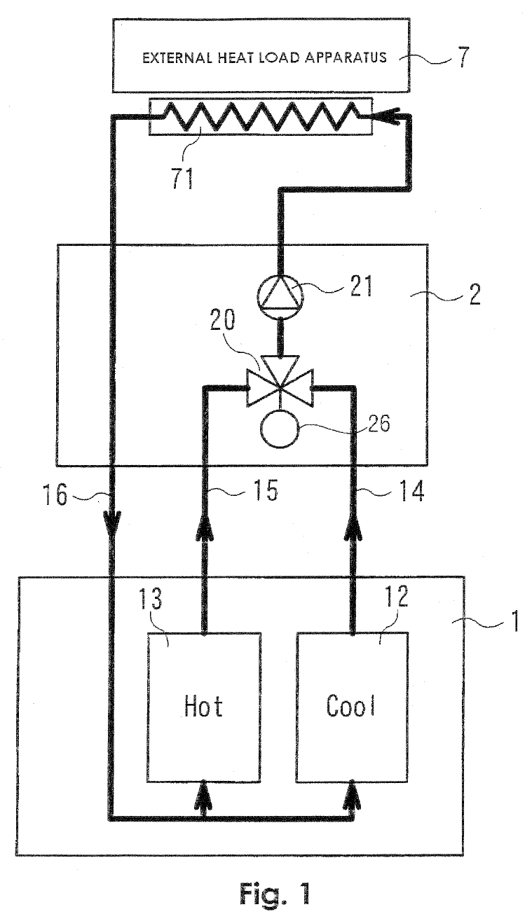

FIG. 1 is a block diagram showing a configuration of the constant temperature controller according to the present invention, in which the reference numeral 1 designates a main unit, 2 a sub unit, 12 a low-temperature circulating heat medium fluid preparation unit, 13 a high-temperature circulating heat medium fluid preparation unit, 20 a three-way valve, 21 an inverter-driven pump serving as a mixing and supplying unit, 26 a control valve, 7 an external heat load apparatus, and 71 a heat exchange chamber.

A low-temperature circulating heat medium fluid produced in the low-temperature circulating heat medium fluid preparation unit 12, and a high-temperature circulating heat medium fluid produced in the high-temperature circulating heat medium fluid preparation unit 13 are supplied to the three-way valve 20 in the sub unit 2, through the cool circulating fluid supply pipe 14 and the hot circulating fluid supply pipe 15, respectively. The control valve 26 of the three-way valve 20 controls the flow volume of the low-temperature circulating heat medium fluid and the high-temperature circulating heat medium fluid, according to the temperature of the external heat load apparatus 7, to thereby produce a circulating heat medium fluid of a target temperature The inverter-driven pump 21 uniformly mixes the circulating heat medium fluid of the target temperature (constant temperature circulating heat medium fluid) and supplies such circulating heat medium fluid to the heat exchange chamber 71, so as to maintain the temperature of the external heat load apparatus 7 at the target temperature.

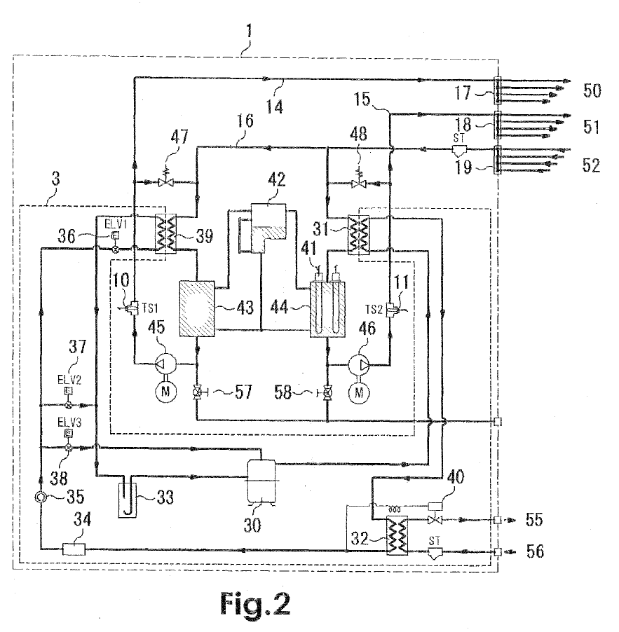

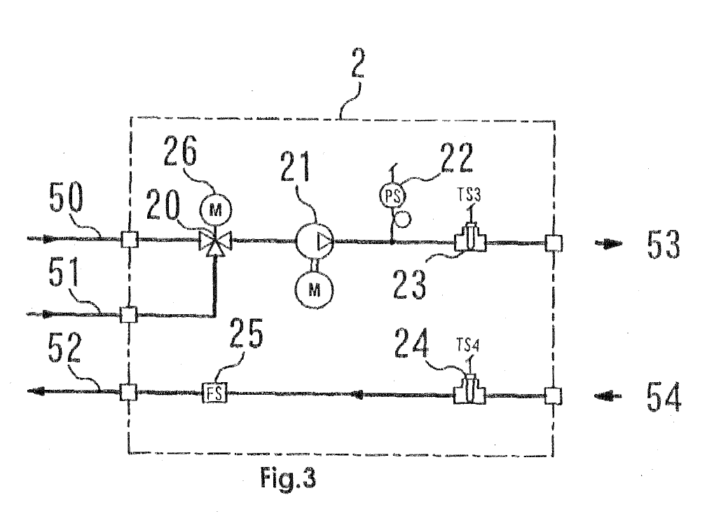

FIG. 2 is a schematic diagram showing a system configuration of a main unit, and FIG. 3 a system configuration of a sub unit, according to the first embodiment.

In the embodiment shown in FIG. 2, the main unit 1 employs a high-temperature side heat medium obtained from a freezer cycle 3 as a heat source for the high-temperature circulating heat medium fluid preparation unit 13, and a low-temperature side heat medium obtained from the freezer cycle 3 as a heat source for the low-temperature circulating heat medium fluid preparation unit 12.

As shown FIG. 2, the freezer cycle 3 has a closed loop including a compressor 30, a freezer discharge gas heat exchanger 31, a condenser 32, a drier 34, an electronic expansion valve for cooling circulating fluid 36, an evaporator 39, a gas-liquid separator and receiver 33, and again the compressor 30. The numeral 35 designates a sight glass, 37 an electronic expansion valve for cooling freezer in take gas, 38 an electronic expansion valve for directly cooling the freezer, 40 a gate valve, 55 a cooling water outlet port for the freezer, and 56 a cooling water inlet port for the freezer.

The low-temperature circulating heat medium fluid (hereinafter simply referred to as cool circulating fluid) supplied from the sub unit 2 through a return pipe 16 is cooled in the evaporator 39, and stored in a cooling side tank 43. At this moment, the aperture of the electronic expansion valve for cooling circulating fluid 36 is controlled according to the temperature of the cool circulating fluid measured by a cooling side temperature sensor 10, so that the temperature of the cool circulating fluid is maintained at the target temperature via the evaporator 39. The cool circulating fluid maintained at the target temperature is forwarded by a cooling pump 45 to the sub unit 2 through the cool circulating fluid supply pipe 14, a cooling side manifold 17, and a cool circulating fluid sub unit supply pipe 50. Also, in FIG. 2 the numeral 42 designates a reserve tank, and 47 a cooling side relief valve.

Meanwhile, the high-temperature circulating heat medium fluid (hereinafter simply referred to as hot circulating fluid) in a heating side tank 44 with a heater 41 is sent by a heating pump 46 to the freezer discharge gas heat exchanger 31, to be heated through heat exchange with a high-temperature heat medium supplied from the compressor 30, and sent to the sub unit 2 through the hot circulating fluid supply pipe 15, a heating side manifold 18, and a hot circulating fluid sub unit supply pipe 51. In FIG. 2, the numeral 11 designates a heating side temperature sensor, 19 a return manifold, 48 a heating side relief valve, 52 a sub unit return pipe, 57 a cool circulating fluid drain valve, and 58 a hot circulating fluid drain valve.

FIG. 3 depicts the configuration of the sub unit 2, in which the cool circulating fluid supplied through the cool circulating fluid sub unit supply pipe 50 and the hot circulating fluid supplied through the hot circulating fluid sub unit supply pipe 51 are mixed through the three-way valve 20 having the control valve 26, and stirred and mixed by the inverter-driven pump 21 so as to turn into a uniform constant temperature circulating fluid, and to be sent to the heat exchange chamber 71 of the external heat load apparatus 7 through a constant temperature circulating fluid supply port 53.

The constant temperature circulating fluid subjected to the heat exchange in the heat exchange chamber 71 returned from a constant temperature circulating fluid return port 54 to the main unit 1 through the sub unit 2 and the sub unit return pipe 52. In FIG. 3, the numeral 22 designates a discharge pressure sensor of constant temperature circulating fluid, 23 a supply temperature sensor of constant temperature circulating fluid, 24 a return temperature sensor of constant temperature circulating fluid, and 25 a discharge flow sensor of constant temperature circulating fluid.

The structure and function of the three-way valve 20 will be described hereunder.

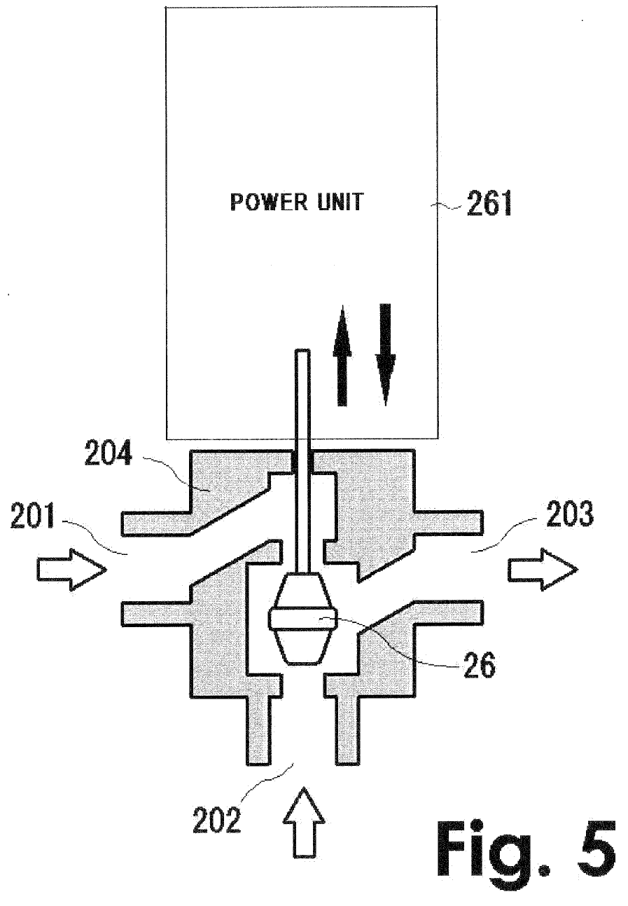

FIG. 5 is a cross-sectional view of the three-way valve 20, in which a driven by a power unit 261 is incorporated in a valve body 204 having a hot circulating fluid inlet port 201, a cool circulating fluid inlet port 202, and a mixed circulating fluid discharge port 203. The power unit 261 may include therein a servo motor, a stepping motor, a diaphragm driven by compressed air, or the like.

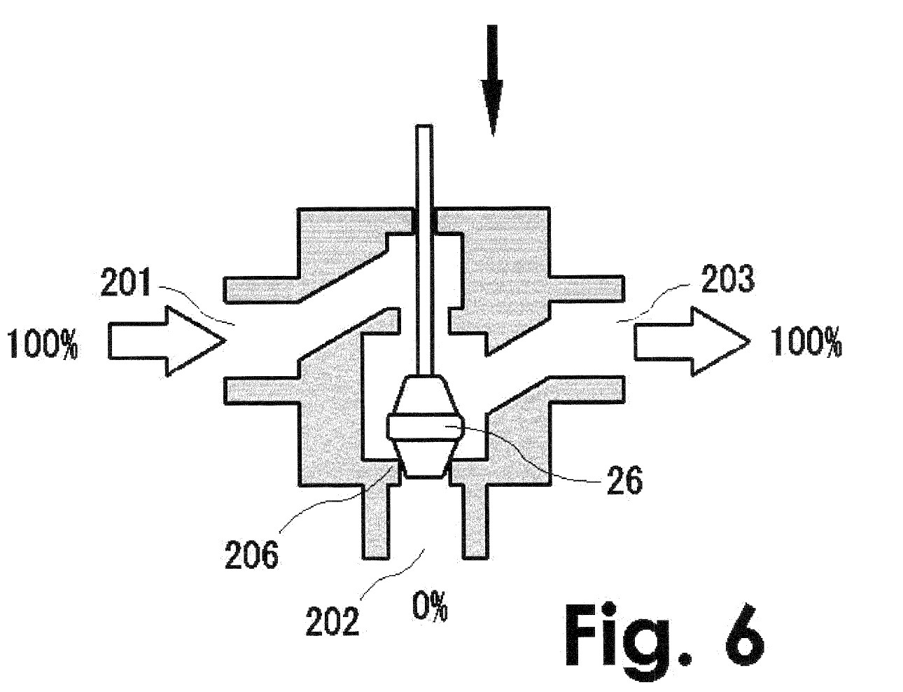

To increase the temperature, the control valve 26 is lowered so as to close a low-temperature side valve seat 206 of the cool circulating fluid inlet port 202 as shown in FIG. 6, i.e. so that the ratio of the hot circulating fluid introduced through the hot circulating fluid inlet port 201 becomes 100%, until the temperature of the constant temperature circulating fluid flowing out through the mixed circulating fluid discharge port 203 reaches the target temperature.

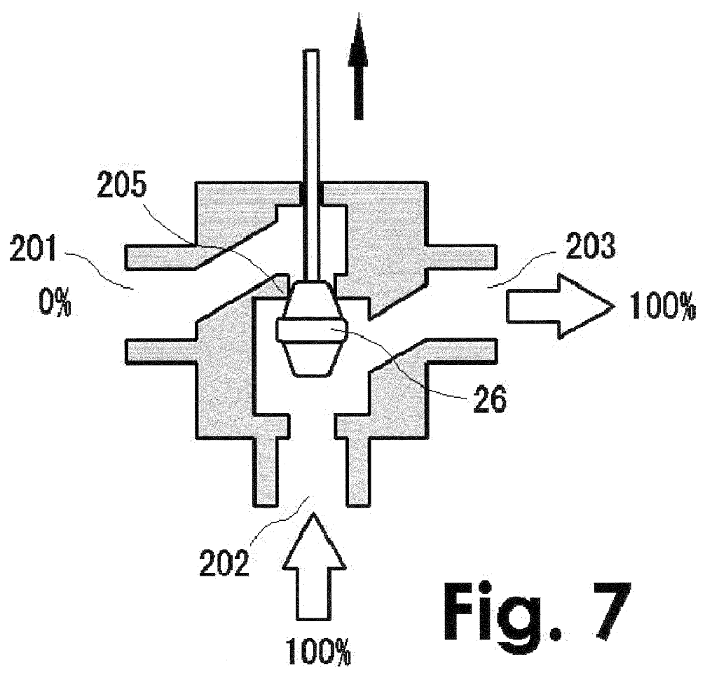

To decrease the temperature, the control valve 26 is lifted so as to close a high-temperature side valve seat 205 of the hot circulating fluid inlet port 201 as shown in FIG. 7, i.e. so that the ratio of the cool circulating fluid introduced through the cool circulating fluid inlet port 202 becomes 100%, until the temperature of the constant temperature circulating fluid flowing out through the mixed circulating fluid discharge port 203 reaches the target temperature.

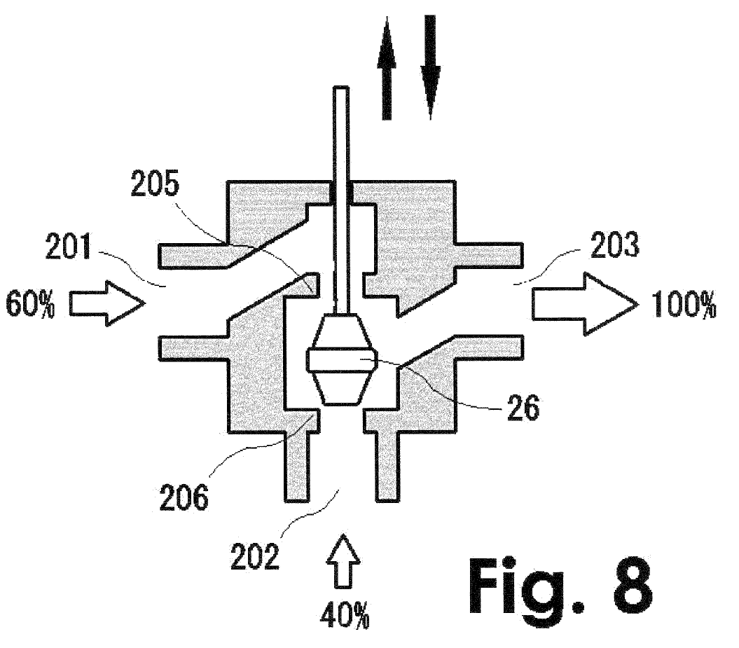

To adjust the temperature in the case where the heat load of the external heat load apparatus 7 becomes greater, the control valve 26 is lifted as shown in FIG. 8, so as to raise the ratio of the cool circulating fluid with respect to the hot circulating fluid, thus making the aperture of the low-temperature side valve seat 206 larger than that of the high-temperature side valve seat 205. In contrast, in the case where the heat load of the external heat load apparatus 7 becomes smaller or is instantaneously turned off, the control valve 26 is lowered so as to make the aperture of the low-temperature side valve seat 206 smaller than that of the high-temperature side valve seat 205, for decreasing the ratio of the cool circulating fluid with respect to the hot circulating fluid

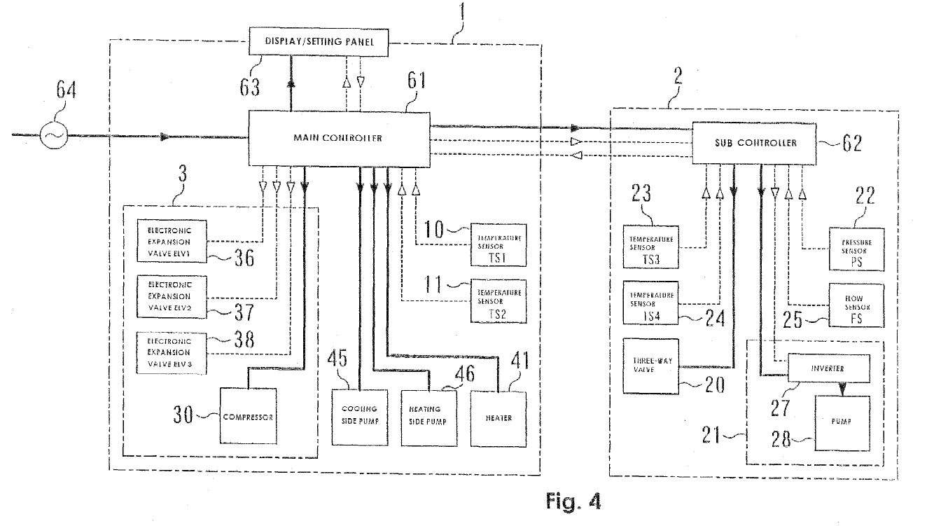

FIG. 4 is a wiring diagram of a control unit for the constant temperature controller, and two control units are provided, namely a main control unit 61 provided in the main unit 1 and a sub control unit 62 provided in the sub unit 2. The main control unit 61 includes a display/setting panel 63, which accepts an input of target values for the main unit 1, i.e. a cool circulating fluid target temperature LSV and a hot circulating fluid target temperature HSV, and target values for the sub unit 2, i.e. a target supply temperature of the constant temperature circulating fluid (or target return temperature thereof) SSV, a target discharge pressure of the constant temperature circulating fluid SPS, and a target discharge flow volume of the constant temperature circulating fluid SFS. In FIG. 4, the numeral 64 designates a power source.

On the cool circulating fluid side of the main unit 1, the aperture of the electronic expansion valve for cooling circulating fluid 36 is adjusted according to the temperature TS1 measured by the cooling side temperature sensor 10, so that the output of the freezer cycle 3 is controlled to maintain the temperature of the cool circulating fluid at the target temperature LSV.

Meanwhile on the hot circulating fluid side, the heater 41 is subjected to PID control according to the temperature TS2 measured by the heating side temperature sensor 11, so that the temperature of the hot circulating fluid is maintained at the target temperature HSV.

The sub unit 2 executes the control of the discharge flow volume or discharge pressure of the constant temperature circulating fluid by the inverter-driven pump, and the control of the temperature of the constant temperature circulating fluid by the three-way valve.

More specifically, in the case of controlling the discharge pressure, the driving frequency of the centrifugal pump 28 via the inverter 27, such that the discharge pressure PS of the discharge pressure sensor of constant temperature circulating fluid 22 agrees with the target pressure SPS.

In the case of controlling the discharge flow volume, the driving frequency of the centrifugal pump 28 via the inverter 27, such that the discharge flow volume FS detected by the discharge flow sensor of constant temperature circulating fluid 25 agrees with the target flow volume SFS.

To control the temperature of the constant temperature circulating fluid, the three-way valve 20 is activated to adjust the volume ratio between the hot circulating fluid and the cool circulating fluid. More specifically, the three-way valve 20 is subjected to the PID control, such that the temperature TS3 measured by the supply temperature sensor of constant temperature circulating fluid 23 agrees with the target temperature SSV. Alternatively, the PID control may be executed with the three-way valve 20 according to the temperature TS4 measured by the return temperature sensor of constant temperature circulating fluid 24.

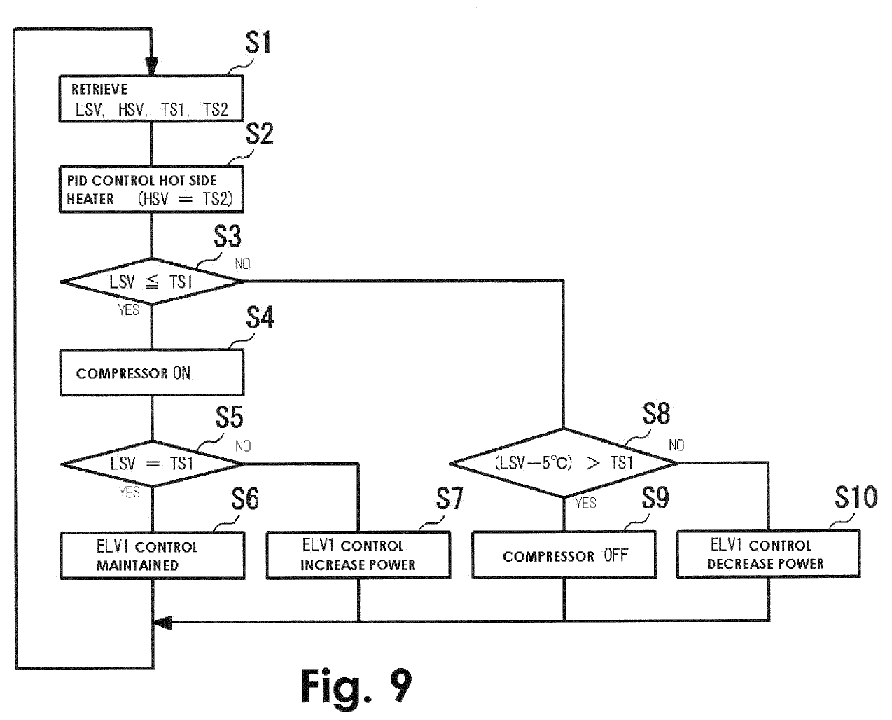

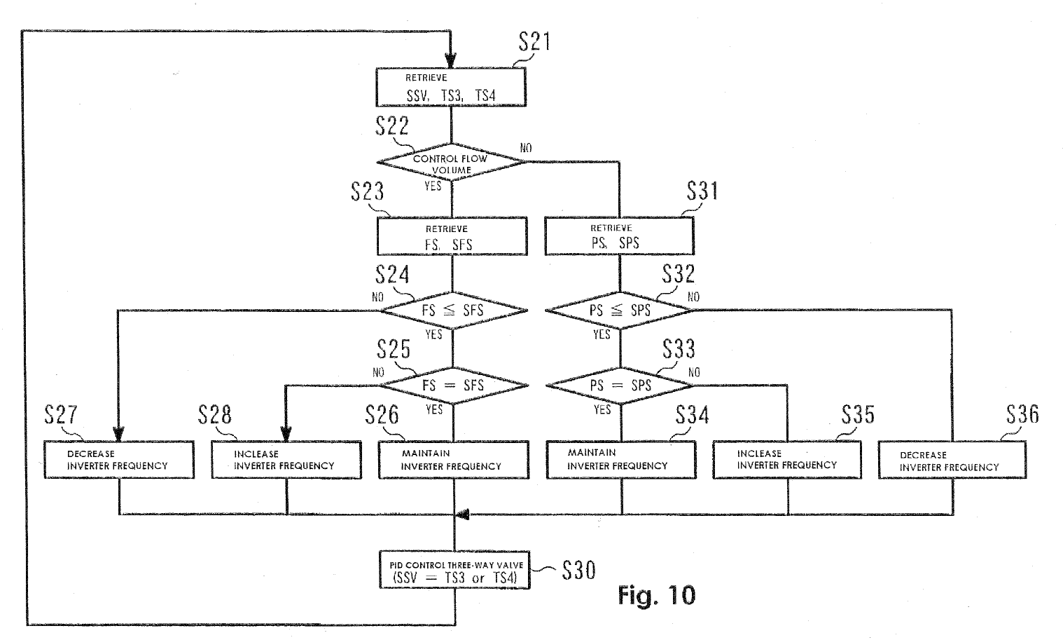

Referring to flowcharts shown in FIGS. 9 and 10, the foregoing operation will be described in further details. FIG. 9 is a flowchart of the circulating fluid temperature control by the main unit 1. At the step S1, the cool circulating fluid target temperature LSV and the hot circulating fluid target temperature HSV are input via the display/setting panel 63 of the main control unit 61. Then the temperature TS1 measured by the cooling side temperature sensor 10 and the temperature TS2 measured by the heating side temperature sensor 11 are retrieved.

At the step S2, the heater 41 is subjected to the PID control, such that the measured temperature TS2 agrees with the hot circulating fluid target temperature HSV.

Then at the step S3, the low-temperature side measured temperature TS1 and the cool circulating fluid target temperature LSV are compared. If the low-temperature side measured temperature TS1 is equal to or higher than the cool circulating fluid target temperature LSV, the program proceeds to the step S4, where the compressor 30 is activated.

At the step S5, again the low-temperature side measured temperature TS1 and the cool circulating fluid target temperature LSV are compared. If the low-temperature side measured temperature TS1 and the cool circulating fluid target temperature LSV are equal, the program proceeds to the step S6, so as to maintain the current output of the freezer cycle, and returns to the step S1.

If the low-temperature side measured temperature TS1 and the cool circulating fluid target temperature LSV do not agree at the step S5, the program proceeds to the step S7, where the cooling power of the freezer cycle is increased, and returns to the step S1.

If the low-temperature side measured temperature TS1 is lower than the cool circulating fluid target temperature LSV at the step S3, the program proceeds to the step S8, where the freezer cycle is stopped in the case where the low-temperature side measured temperature TS1 is more than 5 degrees lower than the cool circulating fluid target temperature LSV, and returns to the step S1. In the case where the low-temperature side measured temperature TS1 is less than 5 degrees lower than the cool circulating fluid target temperature LSV, the program proceeds to the step S10, where the cooling power of the freezer cycle is decreased, and returns to the step S1.

FIG. 10 is a flowchart of the circulating fluid temperature control by the sub unit 2.

At the step S21, the target supply temperature of the constant temperature circulating fluid SSV is input via the display/setting panel 63 of the main control unit 61. Then the temperature TS3 measured by the supply temperature sensor of constant temperature circulating fluid 23, or the temperature TS4 measured by the return temperature sensor of constant temperature circulating fluid 24 is retrieved.

At the step S22, it is decided whether the flow volume control is to be executed. In the case of executing the flow volume control the program proceeds to the step S23, and in the negative case the program proceeds to the step S31.

At the step S23, the measured discharge flow volume FS of the discharge flow sensor of constant temperature circulating fluid 25 and the target discharge flow volume of constant temperature circulating fluid SFS are retrieved.

At the step S24, the measured discharge flow volume FS of the discharge flow sensor of constant temperature circulating fluid 25 is compared with the target discharge flow volume of constant temperature circulating fluid SFS. If the measured value FS is equal to or smaller than the target value SFS the program proceeds to the step S25, where it is decided whether the measured value FS is equal to the target value SFS. In the affirmative case the program proceeds to the step S26, where the current driving frequency of the inverter 27 for the inverter-driven pump 21 is maintained. If negative, the program proceeds to the step S28, where the inverter frequency is increased so as to accelerate the pump rotation.

If the measured value FS is larger than the target value SFS at the step S24 the program proceeds to the step S27, where the inverter frequency is decreased so as to slow down the pump rotation.

If it is decided not to execute the flow volume control at the step S22 the program proceeds to the step S31, and the measured value PS of the discharge pressure sensor of constant temperature circulating fluid 22 and the target discharge pressure of constant temperature circulating fluid SPS are retrieved.

At the step S32, the measured value PS of the discharge pressure sensor of constant temperature circulating fluid 22 and the target discharge pressure of constant temperature circulating fluid SPS are compared. If the measured value PS is equal to or smaller than target value SPS the program proceeds to the step S33, where it is decided whether the measured value PS is equal to the target value SPS. In the affirmative case the program proceeds to the step S34, where the current inverter frequency is maintained. If negative, the program proceeds to the step S35, where the inverter frequency is increased so as to accelerate the pump rotation.

If the measured value PS is larger than the target value SPS at the step S32, the program proceeds to the step S36, where the frequency of the inverter 27 is decreased so as to slow down the pump rotation.

Once the flow volume or flow pressure of the constant temperature circulating fluid is stabilized through the steps S26 to step S28 or the steps S34 to step S36, the three-way valve 20 is controlled at the step S30. Specifically, the position of the control valve 26 of the three-way valve 20 is adjusted via the PID control, such that the temperature TS3 measured by the supply temperature sensor of constant temperature circulating fluid 23, or the temperature TS4 measured by the return temperature sensor of constant temperature circulating fluid 24 becomes equal to the target supply temperature of the constant temperature circulating fluid SSV.

### Second Embodiment

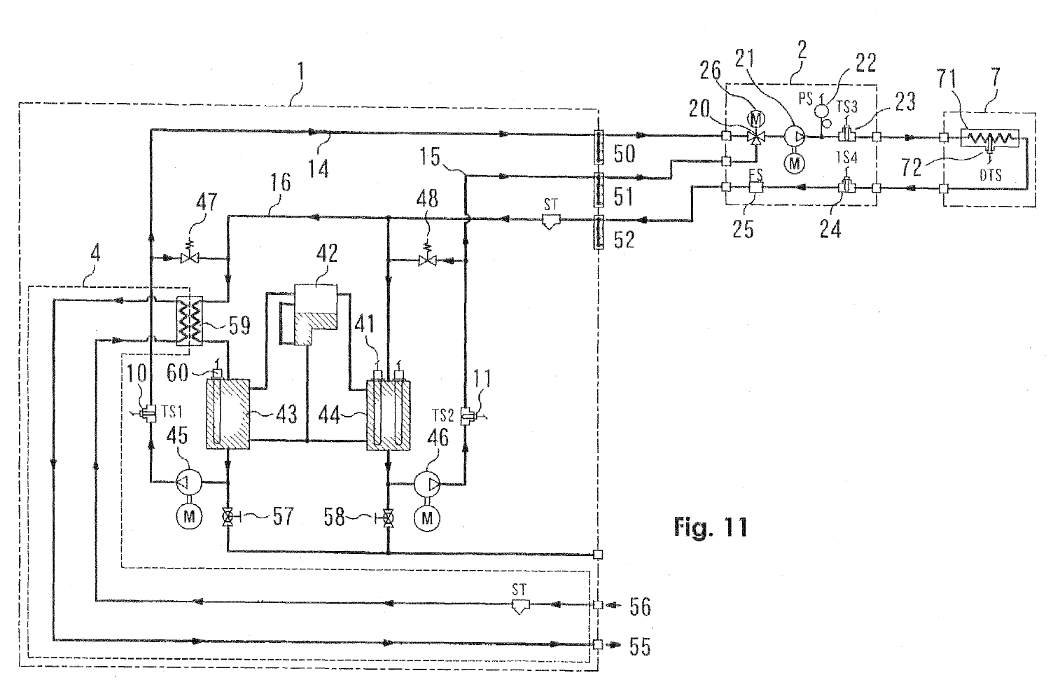

FIG. 11 represents a system that employs the plant utility water as the cooling source of the main unit, and a heater as the heating source thereof.

In FIG. 11, the numeral 4 designates a plant utility water cooling system, in which the plant water introduced through the cooling water inlet port 56 is subjected to heat exchange in the utility water heat exchanger 59 with the cool circulating fluid, at this stage at a higher temperature, returning from the sub unit 2 through the return pipe 16, so as to chill the cool circulating fluid. The chilled cool circulating fluid is stored in the cooling side tank 43, and then sent by the cooling pump 45 to the sub unit 2 through the cool circulating fluid supply pipe 14 and the cool circulating fluid sub unit supply pipe 50. The temperature of the cool circulating fluid is measured by the cooling side temperature sensor 10, and the cooling side heater 60 provided in the cooling side tank 43 is subjected to the PID control until the measured temperature of the cool circulating fluid reaches the target temperature. In FIG. 11, the numeral 47 designates a cooling side relief valve, 52 a sub unit return pipe, and 57 a cool circulating fluid side drain valve.

Meanwhile, the hot circulating fluid heated by the heater 41 in the heating side tank 44 is supplied to the sub unit 2 through the hot circulating fluid supply pipe 15 and the hot circulating fluid sub unit supply pipe 51. The temperature of the hot circulating fluid is measured by the heating side temperature sensor 11, and the heater 41 provided in the heating side tank 44 is subjected to the PID control until the measured temperature of the hot circulating fluid reaches the target temperature. In FIG. 11, the numeral 48 designates a heating side relief valve, 58 a hot circulating fluid side drain valve.

The cool circulating fluid and the hot circulating fluid are joined in the three-way valve 20, and after being stirred and mixed by the inverter-driven pump 21 the mixed fluid is sent to the heat exchange chamber 71 of the external heat load apparatus 7. In this process, the flow volume ratio between the cool circulating fluid and the hot circulating fluid is controlled according to the temperature of the external heat load apparatus 7, so as to achieve the same temperature as the target temperature. The flow volume ratio between the cool circulating fluid and the hot circulating fluid may be decided through the PID control of the control valve 26 of the three-way valve 20, based on the temperature of the external heat load apparatus 7.

The temperature of the external heat load apparatus 7 may be measured by the temperature sensor 72 of the external heat load apparatus 7, the supply temperature sensor of constant temperature circulating fluid 23, or the return temperature sensor of constant temperature circulating fluid 24. Here, the numeral 22 designates the discharge pressure sensor of constant temperature circulating fluid, and 25 the discharge flow sensor of constant temperature circulating fluid.

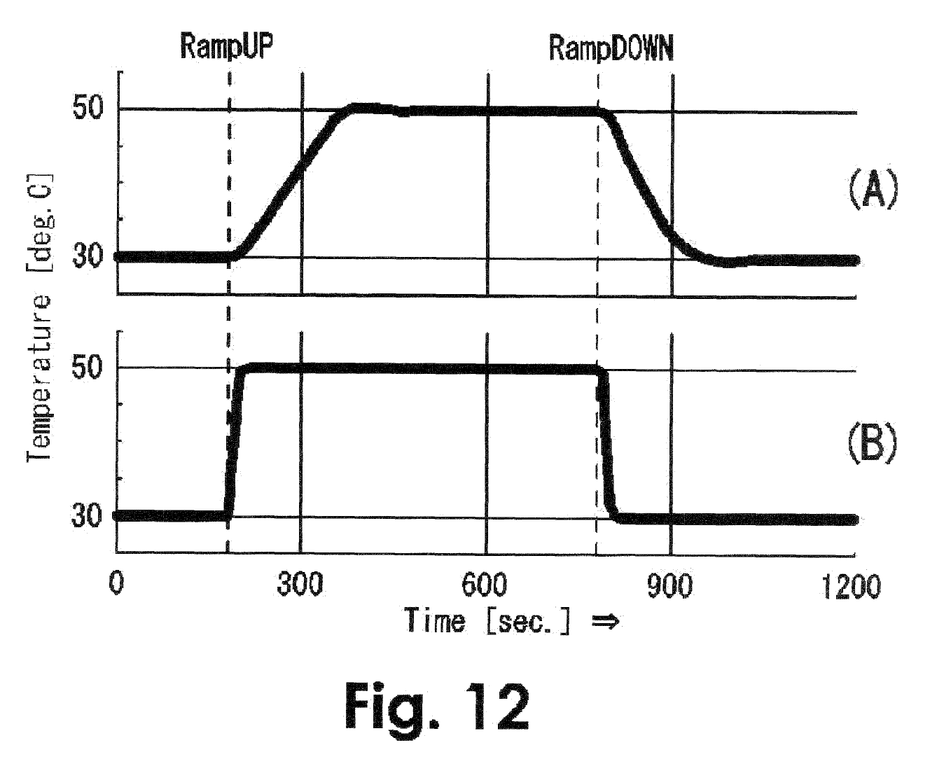

FIGS. 12A and 12B are line graphs for comparison of thermal response between the present invention and a conventional system. The system according to the second embodiment was employed as the system of the present invention, and a chiller unit, which supercools a circulating cooling fluid by a freezer system and micro-adjusts the temperature of the circulating cooling fluid through feedback control based on the temperature of an external heat load apparatus, was employed as the conventional system. The same external heat load apparatus and the same circulating cooling fluid were employed for the both systems, and the discharge flow volume of the circulating cooling fluid was also set at the same volume. Specific conditions for the system according to the present invention were 25° C. as the target of the low-temperature side temperature TS1, and 20 to 23° C. for the plant utility water to be heated by a cooling side heater, for adjustment. The target of the high-temperature side temperature TS2 was set at 60° C.

Data Measurement Conditions:

The thermal response of the above systems was compared under two situations, namely (1) when the target temperature of the external heat load apparatus was raised from +30° C. to +50° C., and (2) when the target temperature of the external heat load apparatus was lowered from +50° C. to +30° C.

FIG. 12A represents the temperature curve of the circulating cooling fluid of the conventional system, and FIG. 12B represents the temperature curve of the circulating cooling fluid of the system according to the present invention. The start of the heating operation (Ramp Up) corresponds the time that the target temperature was switched from 30° C. to 50° C., and the start of the cooling operation (Ramp Down) corresponds to the time that the target temperature was switched from 50° C. to 30° C.

According to FIG. 12A, in the heating operation toward the target temperature by the conventional system, it took 200 seconds before the temperature of the circulating cooling fluid reached 50° C. after the Ramp Up. Besides, the temperature curve protrudes upward after once reaching the target temperature. This indicates the overshooting, and it further took 80 seconds before the fluid temperature stabilized. In the cooling operation toward the target temperature also, it took 170 seconds before the temperature of the circulating cooling fluid reached 30° C. after the Ramp Down. Besides, the temperature curve protrudes downward after once reaching the target temperature. This indicates the undershooting, and it further took 100 seconds before the fluid temperature stabilized.

According to FIG. 12B, in the heating operation toward the target temperature by the system of the present invention, it only took 40 seconds before the temperature of the circulating cooling fluid reached 50° C. after the Ramp Up, and besides the fluid temperature immediately stabilized after reaching the target temperature of 50° C. Thus, by the system according to the present invention, the time necessary for the stabilization of the fluidt emperature in the heating operation has been reduced to only 1/7, in comparison with the conventional system.

In the cooling operation toward the target temperature also, it took as short as 40 seconds before the temperature of the circulating cooling fluid reached 30° C. after the Ramp Down, and besides the fluid temperature immediately stabilized after reaching the target temperature of 30° C. Thus, by the system according to the present invention, the time necessary for the stabilization of the fluid temperature in the cooling operation has been reduced to only 1/6.75, in comparison with the conventional system.

What is claimed is:

1. A constant temperature controller that controls a temperature of an external heat load apparatus through indirect heat exchange with a circulating heat medium fluid, comprising a main unit, including a high-temperature circulating heat medium fluid preparation unit that produces a high-temperature circulating heat medium fluid adjusted to a predetermined temperature and a low-temperature circulating heat medium fluid preparation unit that produces a low-temperature circulating heat medium fluid adjusted to a predetermined temperature; and a sub unit including a constant temperature circulating heat medium fluid preparation unit that directly mixes the high-temperature circulating heat medium fluid and the low-temperature circulating heat medium fluid and controls a flow volume ratio between the high-temperature circulating heat medium fluid and the low-temperature circulating heat medium fluid according to a temperature of the external heat load apparatus, to thereby produce a circulating heat medium fluid of a predetermined target temperature.

2. The constant temperature controller according to claim 1, wherein the high-temperature circulating heat medium fluid preparation unit employs, as a heat source thereof, at least one of a high-temperature side heat medium obtained from a freezer cycle, a heater, and plant utility water, and the low-temperature circulating heat medium fluid preparation unit employs, as a heat source thereof, at least one of a lower-temperature side heat medium obtained from the freezer cycle, a heater, and the plant utility water.

3. The constant temperature controller according to claim 2, wherein the high-temperature side heat medium obtained from the freezer cycle is employed as the heat source for the high-temperature circulating heat medium fluid preparation unit, and the low-temperature side heat medium obtained from the freezer cycle is employed as the heat source for the low-temperature circulating heat medium fluid preparation unit.

4. The constant temperature controller according to claim 2, wherein the heater is employed as the heat source for the high-temperature circulating heat medium fluid preparation unit, and the plant utility water is employed as the heat source for the low-temperature circulating heat medium fluid preparation unit.

5. The constant temperature controller according to claim 2, wherein the heater is employed as the heat source for the high-temperature circulating heat medium fluid preparation unit, and the lower-temperature side heat medium obtained from the freezer cycle is employed as the heat source for the low-temperature circulating heat medium fluid preparation unit.

6. The constant temperature controller according to claim 2, wherein the plant utility water is employed as the heat source for the high-temperature circulating heat medium fluid preparation unit, and the lower-temperature side heat medium obtained from the freezer cycle is employed as the heat source for the low-temperature circulating heat medium fluid preparation unit.

7. The constant temperature controller according to claim 1, further comprising a three-way valve having an inlet port through which the high-temperature circulating heat medium fluid is introduced, an inlet port through which the low-temperature circulating heat medium fluid is introduced, an outlet port through which the constant temperature circulating heat medium fluid is discharged, and a control valve that controls a flow volume ratio between the high-temperature circulating heat medium fluid and the low-temperature circulating heat medium fluid; a stirring, mixing and emitting unit that stirs, mixes and emits the constant temperature circulating heat medium fluid; and a three-way valve control unit that controls aperture of the control valve of the three-way valve, according to the temperature of the external heat load apparatus.

8. The constant temperature controller according to claim 7, wherein the three-way valve control unit has a feedback control function for controlling the flow volume ratio between the high-temperature circulating heat medium fluid and the low-temperature circulating heat medium fluid introduced thereinto, according to one of a temperature of the constant temperature circulating heat medium fluid being supplied to the external heat load apparatus, a temperature of the constant temperature circulating heat medium fluid being discharged from the external heat load apparatus, and a temperature of the working point of the external heat load apparatus.

9. The constant temperature controller according to claim 7, wherein one of a stepping motor, a servo motor, and an air pressure-driven diaphragm is employed as a power unit of the control valve.

10. The constant temperature controller according to claim 8, wherein the feedback function includes a PID control function.

11. The constant temperature controller according to claim 7, wherein a turbo type fluid pump is employed as the stirring, mixing and emitting unit.

12. The constant temperature controller according to claim 11, wherein the turbo type fluid pump is driven by an inverter.

13. The constant temperature controller according to claim 11, wherein one of a centrifugal pump, a diffuser pump, and a cascade pump is employed as the turbo type fluid pump.

14. The constant temperature controller according to claim 1, wherein the main unit and the sub unit are separated from each other, and connected via a supply pipe of the high-temperature circulating heat medium fluid, a supply pipe of the low-temperature circulating heat medium fluid, and a return pipe of the constant temperature circulating heat medium fluid, and the sub unit is located close to the external heat load apparatus.
